(19) United States
(12) Patent Application Publication
(10) Pub. No.: US 2005/0024577 A1
(43) Pub. Date: Feb. 3, 2005

(54) Ferroelectric liquid crystal modulator applied in a liquid crystal projection device

(76) Inventors: Ruey-Yau Tzong, Hsinchu (TW); Robin Hsiung, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/627,597

(22) Filed: Jul. 28, 2003

(51) Int. Cl. C09K 19/02

(52) U.S. Cl. 349/172

(57) ABSTRACT

A liquid crystal projection device includes a light source for providing light beams; an optical lens module for receiving and projecting the light beams along an incident light path; and a FLC modulator disposed on the incident light path for receiving light beams transmitting along the incident light path, the light beams then being modulated into image light beams by the FLC modulator, wherein the image light beams are reflected by the FLC modulator along a reflection light path, and wherein the incident light path and the reflection light path are situated at an non-zero angle.

### BACKGROUND OF THE INVENTION

1. Field of the Invention

The present invention relates to a liquid crystal projection device using a ferroelectric liquid crystal (FLC) modulator. More particularly, the present invention relates to a reflective-type FLC modulator applied in a liquid crystal projection device.

2. Description of the Related Art

FIG. 1 is a schematic diagram depicting a TN (twisted nematic) or STN (super-twisted nematic) liquid crystal molecule 10a and its theoretical rotation angle according to the prior art liquid crystal panel applied in a liquid crystal projection apparatus. As shown in FIG. 1, the theoretical rotation angle of the liquid crystal molecule 10a is 90 degree (indicated with dash line). As known in the art, the liquid crystal molecule 10a functions as a light valve to rotate an incident light beam. It is also well known that the effective rotation angle θ of the liquid crystal molecule 10a is usually smaller than the theoretical rotation angle (90 degree) because the variation factors derived from the manufacturing stage or when the liquid crystal panel is operated at too high or too low temperatures. The insufficient rotation angle θ of the liquid crystal molecule 10a leads to that the projected images have a relatively low contrast ratio. The prior art TN or STN liquid crystal panel has another drawback of long response time when using the rotation angle of the liquid crystal molecule to control gray scale of light. This limits the practical applications of the TN or STN liquid crystal panels.

To overcome the drawbacks of the prior art TN or STN liquid crystal displays, ferroelectric liquid crystal (FLC) displays are developed. As known in the art, the FLC displays are an attractive alternative to conventional TN or STN displays, particularly when large angles of view, gray tints or short switching times are required, e.g. when operating at low temperatures. Referring to FIG. 2, the conventional liquid crystal projection-type display apparatus includes a light source 20a, an optical lens module 30a, a FLC panel 40a, and a projection lens 50a. The optical lens module 30a includes a color plate 31a, a front lens 32a, an integrator unit 33a, a polarity conversion device 34a, a rear lens 35a, and a prism 36a. A light beam from the light source 20a transmits through the optical lens module 30a and incidents to the FLC panel 40a by way of path 60a. This light beam is then modulated into an image light beam and reflected to the polarity conversion device 34a by way of path 70a, and then projected to the projection lens 50a. The path 60a and the path 70a are parallel. It is known that the above-mentioned conventional liquid crystal projection-type display apparatus has a problem of low contrast ratio. Referring to FIG. 3, the reason for low contrast ratio of the above-mentioned conventional liquid crystal projection-type display apparatus is that the effective rotation angle θ₂ is smaller than the theoretical rotation angle θ₁.

In light of foregoing, there is a need to provide an improved liquid crystal projection-type display apparatus that has higher contrast ratio, short response time, and is not costly to fabricate.

### SUMMARY OF THE INVENTION

Accordingly, one object of the invention is to provide a liquid crystal projection device using a ferroelectric liquid crystal (FLC) modulator to increase the image contrast ratio.

It is another object of the present invention is to provide a liquid crystal projection device using a FLC modulator to increase applicability of the FLC modulator.

Still another of the present invention is to provide a liquid crystal projection device using a FLC modulator to lower cost for manufacturing such devices.

To achieve these and other advantages and in accordance with the purposes of the present invention, as embodied and broadly described herein, the present invention provides a liquid crystal projection device. The liquid crystal projection device includes a light source for providing light beams; an optical lens module for receiving and projecting the light beams along an incident light path; and a FLC modulator disposed on the incident light path for receiving light beams transmitting along the incident light path, the light beams then being modulated into image light beams by the FLC modulator, wherein the image light beams are reflected by the FLC modulator along a reflection light path, and wherein the incident light path and the reflection light path are situated at an non-zero angle.

According to one aspect of this invention, a liquid crystal projection device using a FLC modulator is disclosed. The liquid crystal projection device using a FLC modulator includes a light source for providing white light beams; a plurality of FLC modulators for modulating light beams into image light beams; a color separation device for receiving the white light beams and separating the white light beams into a plurality of dichroic light beams according to wavelength, the dichroic light beams incident to the corresponding FLC modulators along incident paths and being reflected to form a plurality of image light beams along reflection light paths, wherein the incident light path and the reflection light path are situated at a non-zero angle; a light integration device disposed on each of the reflection light path; and two light-phase adjusting devices installed between the FLC modulator and the light integration device on two reflection light paths.

Other objects, advantages and novel features of the invention will become more clearly and readily apparent from the following detailed description when taken in conjunction with the accompanying drawings.

### BRIEF DESCRIPTION OF THE DRAWINGS

FIG. 1 is a schematic diagram depicting a TN or STN liquid crystal molecule and its theoretical rotation angle according to the prior art liquid crystal panel applied in a liquid crystal projection apparatus.

FIG. 2 is a schematic view showing a conventional liquid crystal projection-type display apparatus.

FIG. 3 is a schematic view showing a theoretical rotation angle and an effective rotation angle of a liquid crystal molecule when operating at high temperatures.

FIG. 4 is a schematic side view of this invention.

FIG. 5 is a schematic diagram illustrating the observation positions in accordance with this invention.

FIG. 6 is a view of a liquid crystal molecule at point B of FIG. 5.

FIG. 7 is a view of a liquid crystal molecule at point C of FIG. 5.

FIG. 8 is a triple-type FLC modulator for a liquid crystal projection-type display apparatus according to another preferred embodiment of this invention.

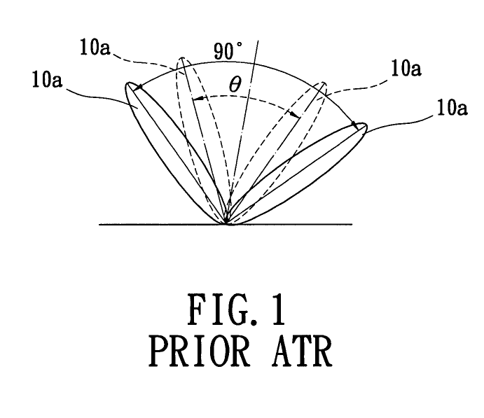

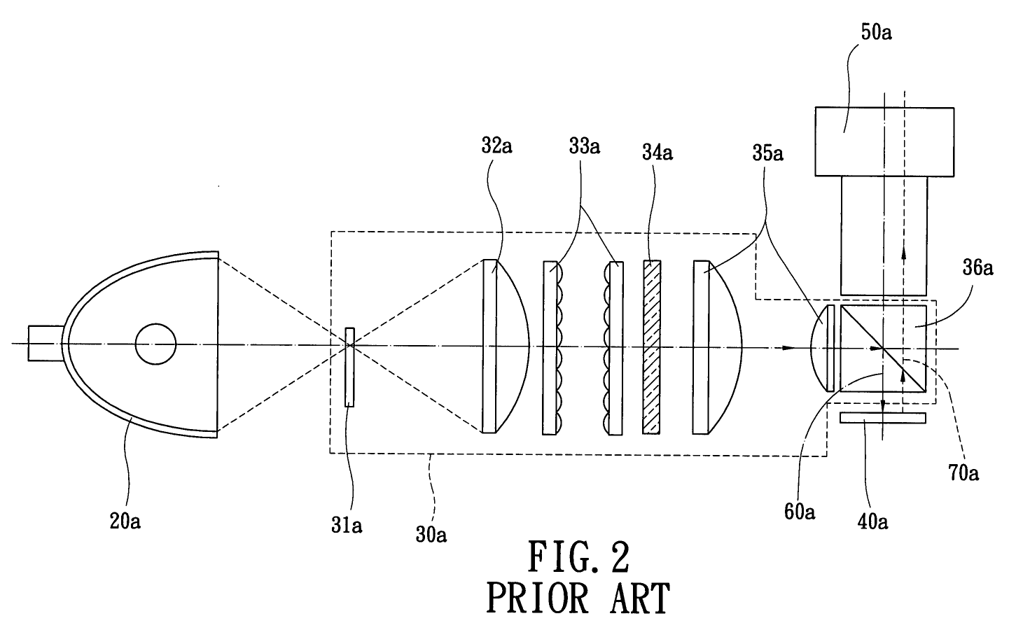

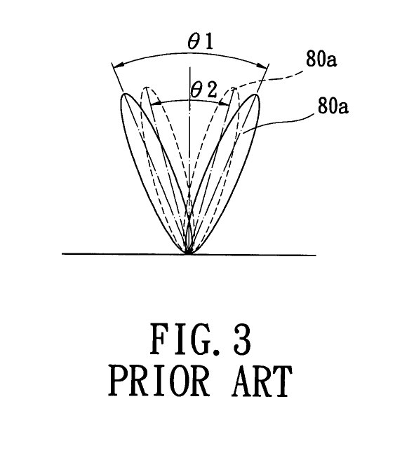

### DETAILED DESCRIPTION OF THE PREFERRED EMBODIMENTS

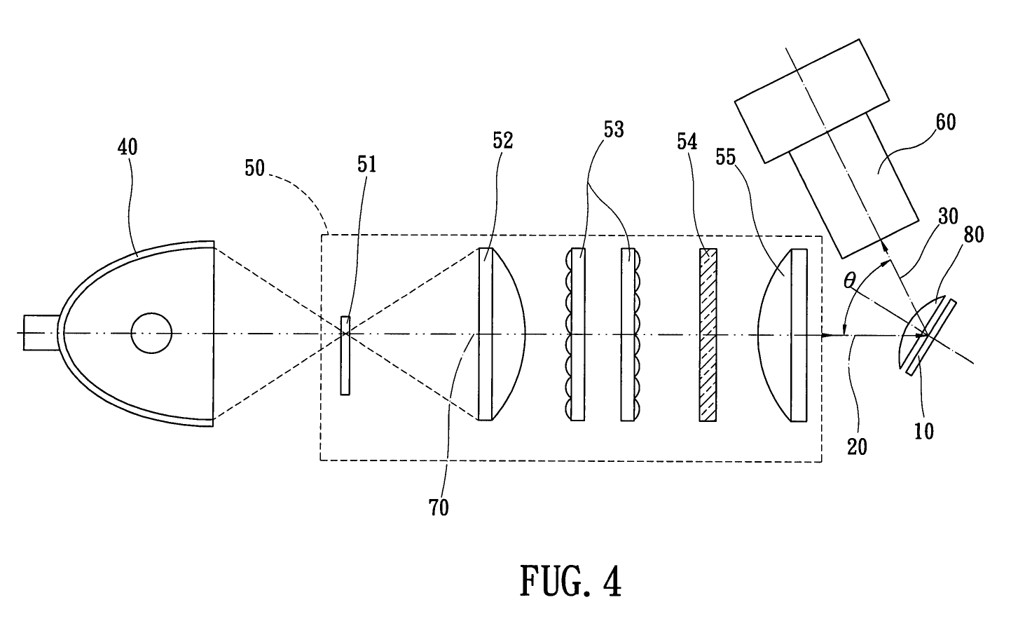

The present invention pertains to a liquid crystal projection-type display apparatus incorporated with an improved ferroelectric liquid crystal (FLC) modulator. Referring to FIG. 4, a light beam by way of path 20 incidents to the FLC modulator 10. This incident light beam is modulated into an image light beam, which is reflected by way of path 30. As indicated, the path 20 and the path 30 are so situated in a non-zero angle position that the liquid crystal molecules in the FLC modulator 10 have a larger optic rotation angle to increase image contrast ratio of the reflected image light beam projected on a screen.

In a case that the liquid crystal projection-type display apparatus is installed with a single-type FLC modulator 10, the liquid crystal projection-type display apparatus includes a light source 40, an optical lens module 50, a FLC modulator 10, and a projection lens 60. The light source 40 is used to provide light beams, which incident to the optical lens module 50. The incident light beam transmits through the optical lens module 50 to the FLC modulator 10 by way of path 20. This light beam is modulated into an image light beam by the FLC modulator 10. The image light beam is reflected by way of path 30. As mentioned, the path 20 and the path 30 are so situated in a non-zero angle position. The projection lens 60 is disposed on the path 30 and is used to receive and project the image light beam.

The optical lens module 50 has an optical axis 70, which is parallel to the path 20. The optical lens module 50 comprises a color plate 51, a front lens 52, an integrator unit 53, a polarity conversion device 54, and a rear lens 55. These elements are sequentially disposed along the optical axis 70 for receiving the light beam. The incident light beam is separated into light beams of different wavelengths, which are also synchronized and polarized. The liquid crystal projection-type display apparatus of this invention further comprises a lens 80 installed between the FLC modulator 10 and the projection lens 60 for receiving image light beams and projecting these light beams to the projection lens 60. The color plate 51 comprises R/B/G color regions.

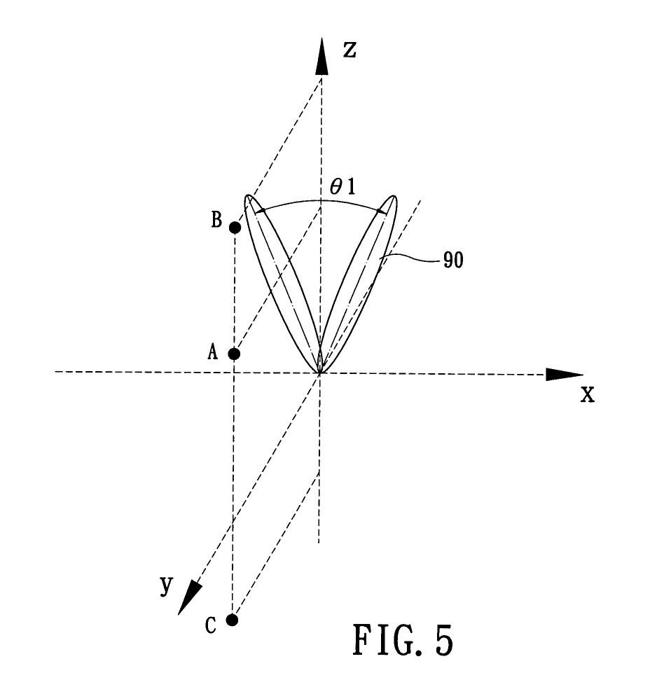

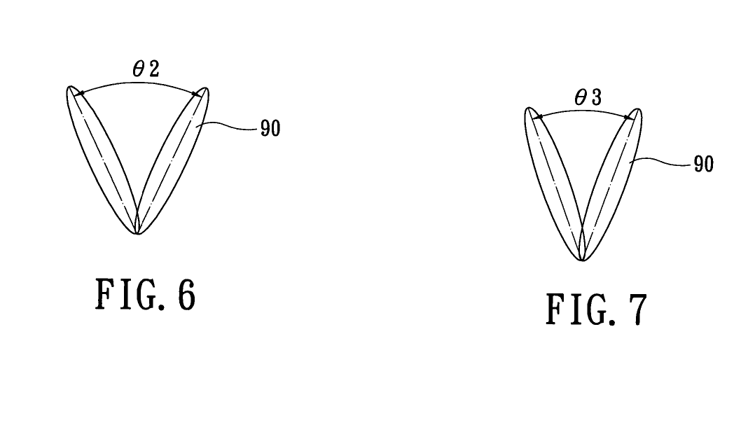

It is advantageous to use the present invention because the prior art TN or STN liquid crystal display is replaced with the FLC modulator 10 that has shorter response time than that of the TN or STN liquid crystal display. Besides, the present invention has improved image contrast ratio when the image light beam is projected on a white screen. This is done by increasing optic rotation angle of the ferroelectric liquid crystal molecules in the FLC modulator 10. Referring to FIG. 5, the rotation angle θ₁ of the object 90 is 45 degree. An observer sees a rotation angle close to the rotation angle θ₁ at point A. Referring to FIG. 5 and FIG. 6, after increasing the viewing angle at point B, the observer sees a rotation angle θ₂ of the object 90 that is larger than the rotation angle θ₁. Referring to FIG. 5 and FIG. 7, when the viewing angle is adjusted to point C, the observer sees a rotation angle θ₃ of the object 90 at point C that is smaller than the rotation angle θ₁. The object 90 is analogous to the ferroelectric liquid crystal molecule in the FLC modulator. Accordingly, it is one feature of the preferred embodiment according to the present invention that by increasing the angle between the incident light beam and the reflected image light beam, the observer can see a larger rotation angle of the ferroelectric liquid crystal molecule, and therefore an increased image contrast ratio. Referring back to FIG. 4, the light beam incidents to the FLC modulator 10 along path 20 and is reflected by the FLC modulator 10 to form the image light beam along path 30. The image contrast ratio is increase because the path 20 and the path 30 are situated in a non-zero angle position.

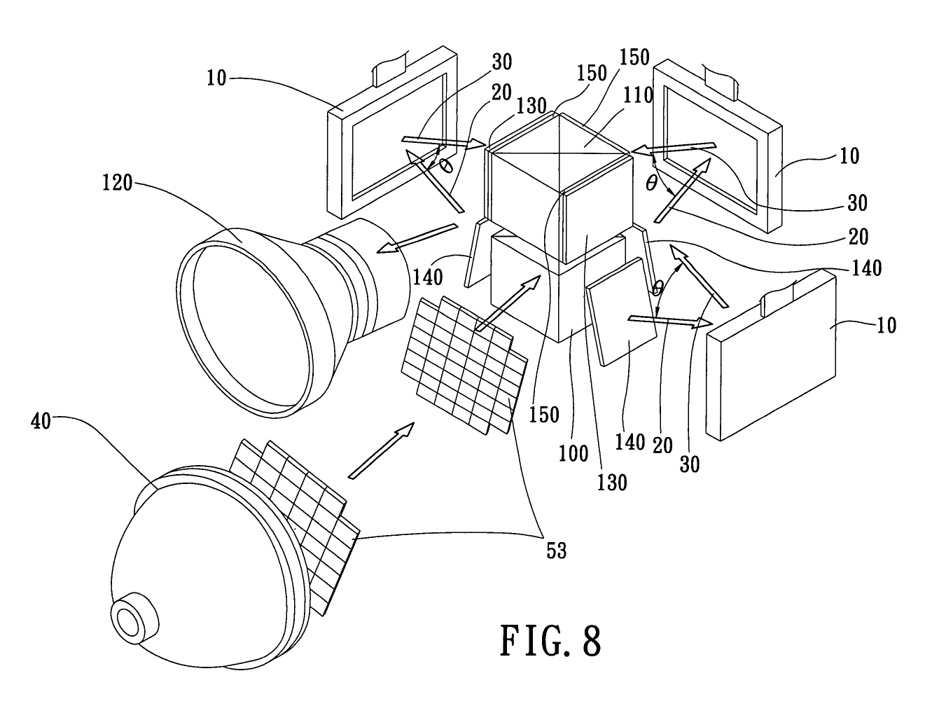

Referring to FIG. 8, in a case that the liquid crystal projection-type display apparatus is installed with a triple-type FLC modulator 10, a light beam from the light source 40 incidents to the color separation device 100 through the integrator unit 53. The color separation device 100 is used to receive a white light beam and separate the white light beam into red, green, and blue (R/G/B) light beams. These separated light beams incident to the respective FLC modulators 10 by way of corresponding paths 20. Each FLC modulator 10 modulates corresponding light beam into an image light beam, which is then reflected to a light integration device 160 by way of path 30. It is noted that the path 20 and the path 30 is situated at an angle θ of between 20 and 40 degree. Two light-phase adjusting devices 130 are installed on two of the three paths 30 for adjusting light phase of two of the three separated image light beams. The projection lens 120 is used to receive and project the confluent image light beams transmitted from the light integration device 110. Three polarization devices 140 are disposed on respective paths 20 for polarizing the corresponding light beams. The polarization devices 140 may be polarizing sheets. Three light purifying devices 150 are installed on respective paths 30 for purifying each of the three image light beams. The light purifying device 150 may be a polarizing sheet. The color separation device 100 may be an intersecting prism. The light integration device 110 may be a SPS light integration device.

To sum up, the present invention provides a liquid crystal projection display apparatus using an improved FLC modulator, thereby increasing image contrast ratio and cost of manufacturing such devices.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A liquid crystal projection device using a ferroelectric liquid crystal (FLC) modulator, the liquid crystal projection device comprising:
a ferroelectric liquid crystal (FLC) modulator for receiving an incident light beam transmitting along an incident light path, the incident light beam then being modulated into an image light beam by the FLC modulator, wherein the image light beam is reflected by the FLC modulator along a reflection light path, and wherein the incident light path and the reflection light path are situated at an non-zero angle.

2. The liquid crystal projection device as claimed in claim 1 wherein the incident light path and the reflection light path are situated at an angle of between 20 and 40 degree.

3. A liquid crystal projection device using a ferroelectric liquid crystal (FLC) modulator, comprising:
a light source for providing light beams;
an optical lens module for receiving and projecting the light beams along an incident light path; and
a ferroelectric liquid crystal (FLC) modulator disposed on the incident light path for receiving light beams transmitting along the incident light path, the light beams then being modulated into image light beams by the FLC modulator, wherein the image light beams are reflected by the FLC modulator along a reflection light path, and wherein the incident light path and the reflection light path are situated at an non-zero angle.

4. The liquid crystal projection device using a ferroelectric liquid crystal (FLC) modulator as claimed in claim 3 further comprising a projection lens disposed on the reflection light path for receiving and projecting the image light beams.

5. The liquid crystal projection device using a ferroelectric liquid crystal (FLC) modulator as claimed in claim 4 further comprising a lens disposed between the FLC modulator and the projection lens for receiving the image light beams from the FLC modulator and projecting the received image light beams to the projection lens.

6. The liquid crystal projection device using a ferroelectric liquid crystal (FLC) modulator as claimed in claim 3 wherein the optical lens has an optical axis in parallel with the incident light path.

7. The liquid crystal projection device using a ferroelectric liquid crystal (FLC) modulator as claimed in claim 3 wherein the optical lens comprises a color plate, a front lens, an integrator unit, a polarity conversion unit, and a rear lens, which are sequentially disposed along an optical axis for receiving the light beams, and the light beams are modulated into light beams with different wavelengths which are uniformed and polarized.

8. The liquid crystal projection device using a ferroelectric liquid crystal (FLC) modulator as claimed in claim 7 wherein the color plate has R/G/B regions to form different colors of light.

9. A liquid crystal projection device using a ferroelectric liquid crystal (FLC) modulator, comprising:
a light source for providing white light beams;
a plurality of ferroelectric liquid crystal (FLC) modulators for modulating light beams into image light beams;
a color separation device for receiving the white light beams and separating the white light beams into a plurality of dichroic light beams according to wavelength, the dichroic light beams incident to the corresponding FLC modulators along incident paths and being reflected to form a plurality of image light beams along reflection light paths, wherein the incident light path and the reflection light path are situated at a non-zero angle;
a light integration device disposed on each of the reflection light path; and
two light-phase adjusting devices installed between the FLC modulator and the light integration device on two reflection light paths.

10. The liquid crystal projection device using a ferroelectric liquid crystal (FLC) modulator as claimed in claim 9 wherein the incident light path and the reflection light path are situated at an angle of between 20 and 40 degree.

11. The liquid crystal projection device using a ferroelectric liquid crystal (FLC) modulator as claimed in claim 9 further comprising a plurality of polarizing device disposed on corresponding incident light paths.

12. The liquid crystal projection device using a ferroelectric liquid crystal (FLC) modulator as claimed in claim 9 further comprising a plurality of purifying device disposed on corresponding incident light paths for purifying the image light beams.

13. The liquid crystal projection device using a ferroelectric liquid crystal (FLC) modulator as claimed in claim 9 further comprising an integrator disposed between the light source and the color separation device for integrating the light beams from the light source.

14. The liquid crystal projection device using a ferroelectric liquid crystal (FLC) modulator as claimed in claim 9 wherein the color separation device is a intersecting prism.
